(19) United States
(12) Patent Application Publication
(10) Pub. No.: US 2004/0067755 A1
(43) Pub. Date: Apr. 8, 2004

(54) Direct routing of wireless calls

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/264,134

(22) Filed: Oct. 3, 2002

(51) Int. Cl. H04Q 7/20

(52) U.S. Cl. 455/445; 455/433; 455/432.3

(57) ABSTRACT

The present invention provides for directly routing an inbound call to a wireless user element through a servicing mobile switching center (MSC), instead of routing the call to a home MSC and on to the servicing MSC. To facilitate direct routing of a call to a servicing MSC, a tandem switch in the wireline network is given access to the home location register (HLR) database of the wireless network. As such, the tandem switch can determine the MSC servicing a user element, and then route the call to the servicing MSC directly, instead of via the home MSC.

### FIELD OF THE INVENTION

The present invention relates to telephony communications, and in particular to routing calls from a wireline network to a wireless network in a direct and efficient manner.

### BACKGROUND OF THE INVENTION

With the ever-increasing number of cellular users and cellular networks, an increasing number of calls between a wireline network, such as the public switched telephone network (PSTN), and wireless networks are made. Although the wireline network in a given region is typically provided by a single network operator, this is not the case for the wireless network. Instead, there are numerous networks provided by different providers using different communication technologies and standards.

Typically, mobile switching centers (MSCs) within each of the wireless networks will cooperate with local tandem switches in the wireline network to facilitate calls traversing the wireline and wireless networks. The tandem switch provides a common switching point between a number of end office switches supporting various customer premise equipment (CPE), such as telephones, and the mobile switching centers of the various wireless networks. The MSCs generally support a number of base stations, which facilitate wireless communications with various user elements, such as mobile telephones, personal digital assistants, and wireless modems. Calls directed to a user element of a wireless network from the wireline network are initially handled by the supporting end office switch. The end office switch will route the call to the local tandem switch, which will identify the intended destination of the call, the user element, and determine the home MSC for the user element. Typically, the tandem switch can use the directory number associated with the user element and find the home MSC from an associated database.

Once the home MSC is identified, the local tandem switch will route the call to the home MSC, which will determine if the user element is within an area serviced by the home MSC or if it is being serviced by another MSC in the associated wireless network or another wireless network. If the user element is serviceable by the home MSC, wireless communications will be effected via an appropriate base station. If the user element is being serviced by another MSC inside or outside of the associated wireless network, the home MSC will forward the call to the servicing MSC, which will facilitate wireless communications with the user element.

In each wireless network, the various MSCs have access to a home location register (HLR) database, which keeps track of the location and other necessary information about user elements homed to MSCs in the wireless network. Importantly, the HLR database is updated to keep track of the location of roaming user elements. The location information will identify a servicing MSC for a roaming user element. As such, when a call is directed to a home MSC, it will access the HLR database to determine the servicing MSC for the user element, and forward the call to the servicing MSC.

Unfortunately, routing calls from the wireline network through the home MSC and on to the servicing MSC for a roaming user element uses unnecessary resources and increases the time required to set up the call. As such, there is a need for a way to directly route calls to the MSC servicing a user element, instead of having to route a call through a home MSC when the user element is roaming and being serviced by a MSC other than the home MSC.

### SUMMARY OF THE INVENTION

The present invention provides for directly routing an inbound call to a wireless user element through a servicing mobile switching center (MSC), instead of routing the call to a home MSC and on to the servicing MSC. To facilitate direct routing of a call to a servicing MSC, a tandem switch in the wireline network is given access to the home location register (HLR) database of the wireless network. As such, the tandem switch can determine the MSC servicing a user element, and then route the call to the servicing MSC directly, instead of via the home MSC. In addition, the tandem switch can be used to route inbound calls to a voicemail system if the wireless user element cannot receive or answer the inbound call.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates call routing between a wireline network and a wireless network according to the prior art.

FIG. 2 illustrates call routing between a wireline network and a wireless network according to one embodiment of the present invention.

FIG. 3 illustrates call routing between a wireline network and a wireless network according to a second embodiment of the present invention.

FIG. 4 illustrates call routing between a wireline network and a wireless network according to a third embodiment of the present invention.

FIG. 5 is a block representation of a tandem switch according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

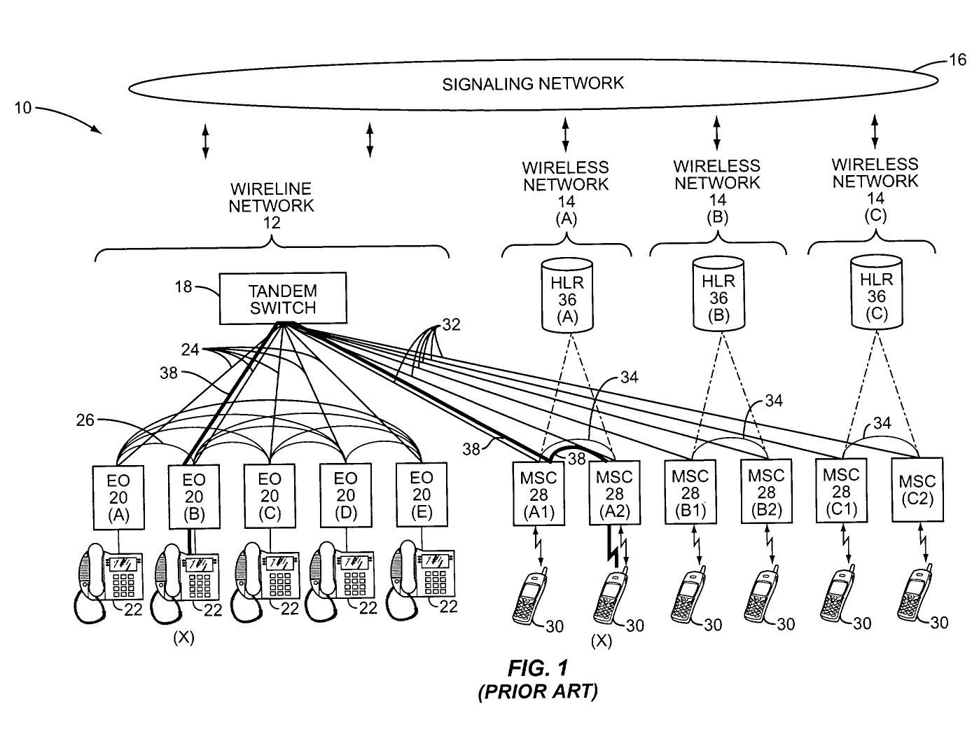

The present invention provides for directly routing an inbound call to a wireless user element through a servicing mobile switching center (MSC), instead of routing the call to a home MSC and on to the servicing MSC. To facilitate direct routing of a call to a servicing MSC, a tandem switch in the wireline network is given access to the home location register (HLR) database of the wireless network. As such, the tandem switch can determine the MSC servicing a user element, and then route the call to the servicing MSC directly, instead of via the home MSC. The present invention is illustrated in contrast with the call routing technique of the prior art, which is illustrated in FIG. 1.

As depicted, a communication environment 10 includes a wireline network 12, such as the public switched telephone network (PSTN), and numerous wireless networks 14 (A, B, and C) supporting wireless communication. A signaling network 16, such as a signaling system 7 (SS7) network, cooperates with both the wireline network 12 and the wireless networks 14 to facilitate call signaling and various telephony services as are well understood by those skilled in the art.

The wireline network 12 generally includes a centralized trunking switch, referred to herein as a tandem switch 18, which services numerous end office (EO) switches 20 (A-E). Each end office switch 20 will directly support various types of customer premise equipment (CPE) 22 in traditional fashion. The CPEs 22 are generally connected to the end office switches 20 via telephony lines, while the end office switches 20 are connected to the tandem switch 18 via end office trunks 24. Generally, a mesh of interworking trunks 26 are used to connect the various end office switches 20 to each other, wherein most calls from one end office switch 20 to another can be directly routed without going through the tandem switch 18. Generally, the tandem switch 18 is used to facilitate calls between CPEs 22 of the various supported end office switches 20 and one of the wireless networks 14, competitive local exchange carriers, interexchange carriers, internet service providers, and other disparate networks. Routing between the end office switches 20 or involving the tandem switch 18 will likely invoke the services of the signaling network 16 in traditional fashion.

The wireless networks 14 are made up of multiple MSCs 28 (A1, A2, B1, B2, C1, and C2), which support wireless communications for user elements 30 via base stations or other wireless access points (not shown). As noted, the user elements 30 may include various types of wireless communication devices, such as mobile telephones, wireless modems, and personal digital assistants. The MSCs 28 are each connected to the tandem switch 18 via MSC trunks 32. Further, inter-MSC trunks 34 may be provided between MSCs 28 within any given wireless network 14. Notably, trunking is typically not provided between MSCs 28 of different wireless networks 14. Of importance to the present invention, HLR databases 36 (A, B, and C) are associated with each of the wireless networks 14, and are accessible by the corresponding MSCs 28 in traditional fashion to allow the MSCs 28 to determine the location of user elements 30 that are homed to that particular MSC 28. Notably, the user elements 30 that are homed to a home MSC 28 may be within the serviceable network of the home MSC 28, or may be serviced by a remote, servicing MSC 28. As noted, calls originating in the wireline network 12 and terminating at a user element 30 have traditionally been routed through the home MSC 28, which will route the call on to the servicing MSC 28. The home MSC 28 will identify the servicing MSC 28 using the HLR database 36.

As illustrated, the routing of a call from CPE 22 (X) to user element 30 (X) is illustrated via routing path 38. The call is initially routed from the end office switch 20 (B) that supports the CPE 22 (X) to the tandem switch 18. The tandem switch 18, upon receiving a request to establish a call with the user element 30 (X), will access a database based on the directory number or other indicia, indicating that the user element 30 (X) is a wireless entity and homed to home MSC 28 (A1). The database can be separate from the tandem switch 18 or built in as in this embodiment. The tandem switch 18 will then forward the call to the home MSC 28 (A1), which will access the HLR database 36 (A) to determine the location of the user element 30 (X). In this example, assume that the user element 30 (X) is currently being serviced by MSC 28 (A2) in the wireless network 14 (A). As such, the home MSC 28 (A1) will forward the call to the servicing MSC 28 (A2) via the inter-MSC trunk 34. As illustrated, the routing of the call between the CPE 22 (X) and the user element 30 (X) is inefficient and wastes resources at the home MSC 28 (A1) and within the inter-MSC trunk 34, as well as extending call routing time, which increases the time associated with establishing the call.

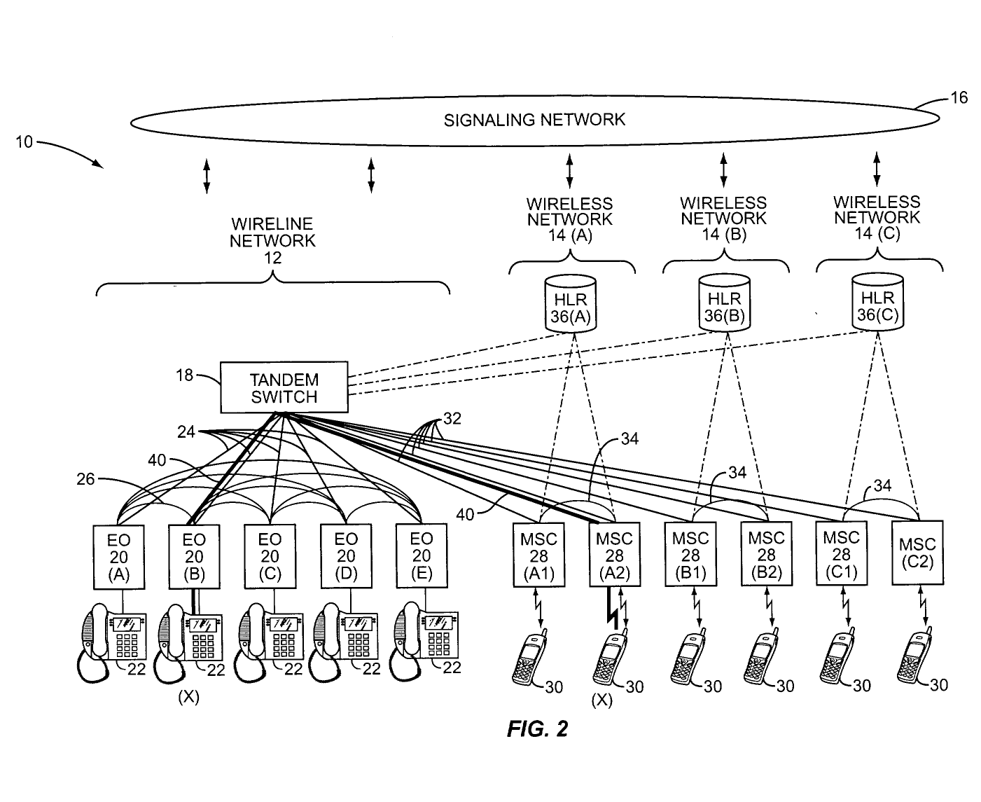

In contrast with the above, the present invention allows the tandem switch 18 to directly access the HLR database 36 for the user element 30 to identify the servicing MSC 28, which may be the home MSC 28 or other MSC 28, and directly route the call for the user element 30 to the servicing MSC 28. When the servicing MSC 28 is not the home MSC 28, the home MSC 28 is bypassed, as the call is directly routed to the servicing MSC 28. An exemplary call routing path 40 is illustrated in FIG. 2, wherein a call originates from CPE 22 (X) and is directed to user element 30 (X), which is serviced by servicing MSC 28 (A2) and homed to home MSC 28 (A1). In operation, the call initiated by CPE 22 (X) is recognized by the end office switch 20 (B) and forwarded to the tandem switch 18, which will access a database to determine that the call is intended for a wireless user associated with user element 30 (X), which is homed to wireless network 14 (A). The tandem switch 18 will then query the HLR database 36 (A) for the wireless network 14 (A) for the servicing MSC 28 of user element 30 (X). The HLR database 36 (A) will send a message back to the tandem switch 18 identifying the servicing MSC 28 (A2) for the user element 30 (X). The tandem switch 18 will then route the call directly to the servicing MSC 28 (A2) for the user element 30 (X). Thus, if the servicing MSC 28 is not the home MSC 28, the call is not routed to the home MSC 28 and then to the servicing MSC 28, but is instead routed directly to the servicing MSC 28. Such direct routing minimizes the impact on resources of the home MSC 28 and any inter-MSC trunks 34, which would have had to support the call once it was established. Further, the time necessary for establishing the call is significantly reduced by eliminating unnecessary routing steps.

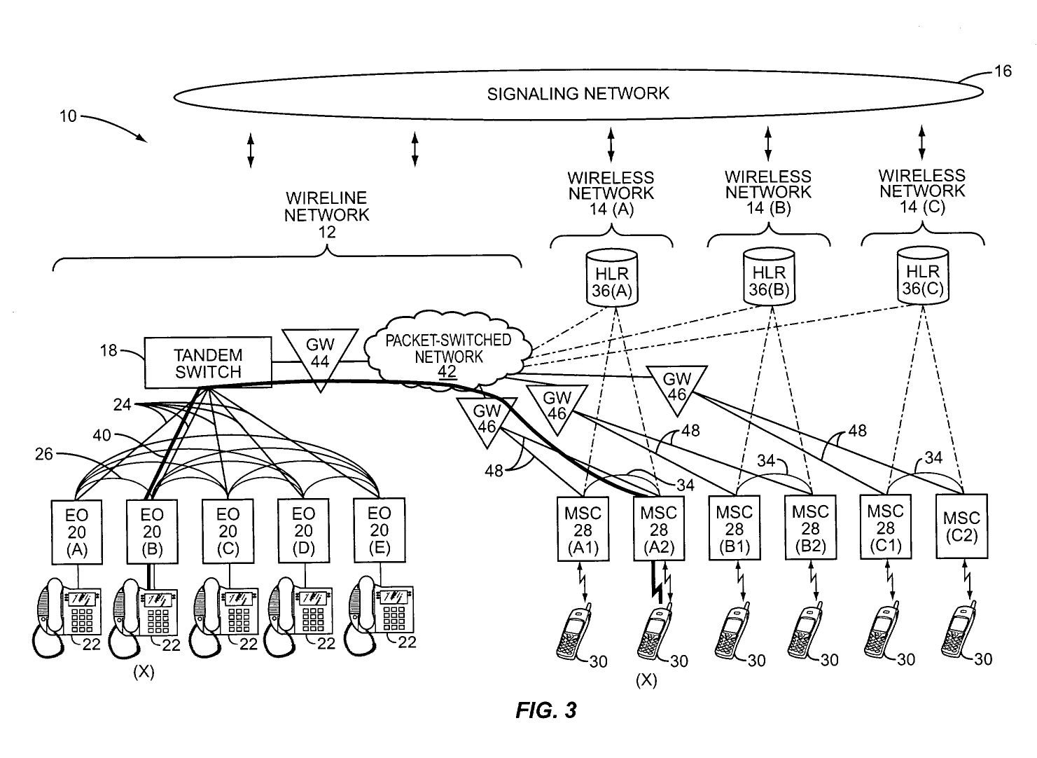

Those skilled in the art will recognize that the embodiment illustrated in FIG. 2 provides for trunking between the tandem switch 18 and the MSCs 28 of the various wireless networks 14. In addition to direct trunking, certain embodiments may require additional switches within the trunking paths between the tandem switch 18 and the MSCs 28. Further, and as illustrated in FIG. 3, the call may be routed and established through an intermediate packet-switched network 42, wherein a gateway 44 provides a packet-to-circuit-switched interface between the tandem switch 18 and the packet-switched network 42. Similarly, gateways 46 may provide a packet-to-circuit-switched interface between the packet-switched network 42 and the respective MSCs 28 of the various wireless networks 14. Trunks 48 may be provided between the gateways 46 and the respective MSCs 28. In this embodiment, a control link may be established between the tandem switch 18 and the gateway 46 via the packet-switched network 42. Those skilled in the art will recognize further variations in the network architecture that do not depart from the concepts of the present invention.

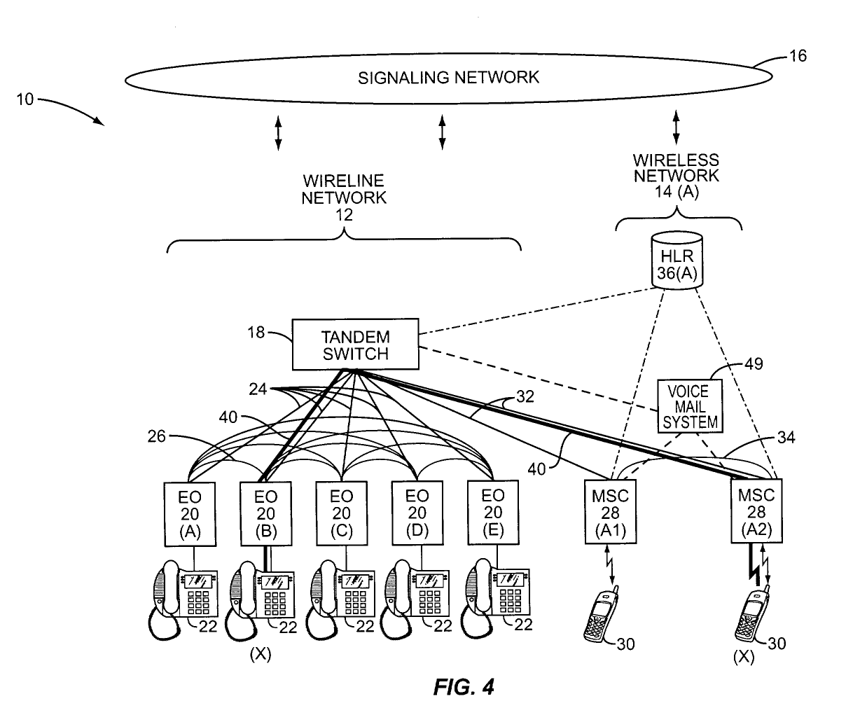

Turning to FIG. 4, in addition to routing inbound calls to the servicing MSC 28, the tandem switch 18 may be used to route the call to a voicemail system 49 if the user or user element 30 cannot be reached or answer the call, thereby avoiding using extra resources at the home or servicing MSC 28. As part of the initial query from the tandem switch 18 to locate the servicing MSC 28, the HLR database 36 also indicates in the information passed back to the tandem switch 18 if the user or user element 30 subscribes to a voicemail system. If the user element 30 is currently unreachable, the HLR database 36 will flag this situation to the tandem switch 18, which will route the call directly to voicemail system 49 if the user or user element 30 subscribes to that service. If the user element 30 is busy with another call or does not answer the call, the servicing MSC 28 will release the call and flag to the tandem switch 18 that the call was not answered, prompting the tandem switch 18 to forward the inbound call this time to the voicemail system 49.

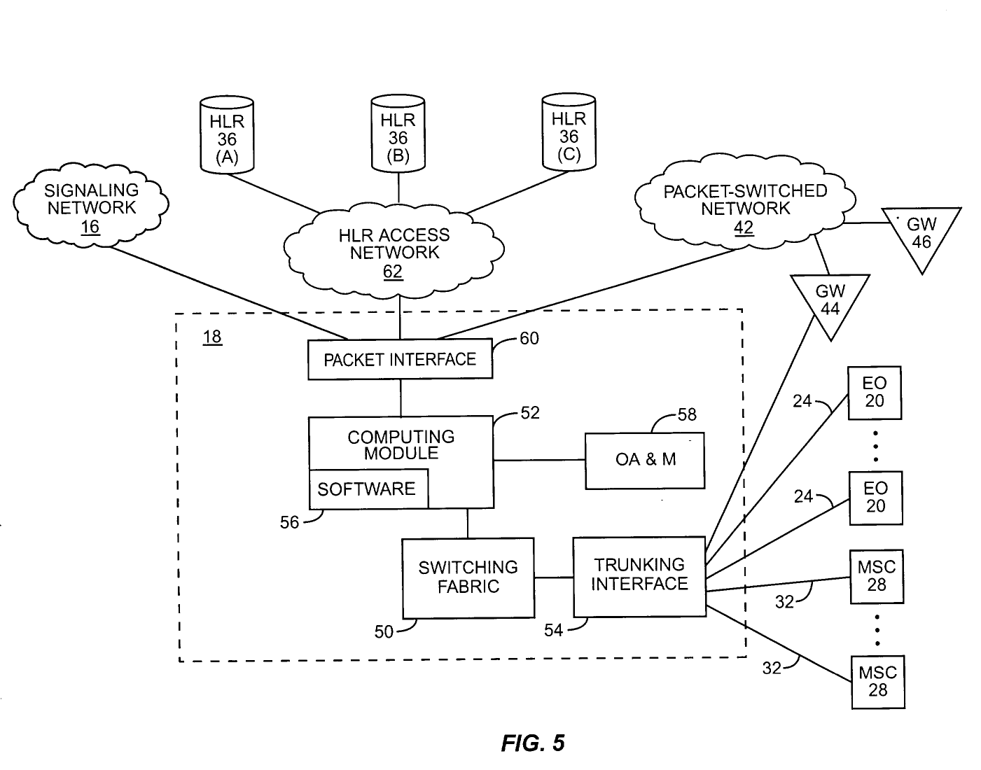

An exemplary tandem switch 18 is illustrated in FIG. 5. The tandem switch 18 is represented generically, and is intended to cover the logical functionality of various types of switching systems capable of implementing the above-described functionality. The tandem switches 18 may be implemented in a variety of ways using different equipment types, such as Nortel Networks Limited's DMS-200 tandem switching system for TDM implementations or Nortel Networks Limited's Succession for a voice on packet implementation. The tandem switch 18 typically includes a switching fabric module 50, a computing module 52 including the necessary software 56 for operation, a trunking interface 54, and an operations/administration and maintenance (OA&M) module 58. A packet interface 60 or other interface may be provided to facilitate communications with the HLR databases 36 via some type of HLR access network 62, which may be a packet-switched network separate from or associated with the signaling network 16, the Internet, or other proprietary network facilitating such access. Similarly, access for control of the gateways 44, 46 may be provided through the packet-switched network 42 or like network.

The switching fabric module 50 may include logical and physical switches for interconnecting various trunks and circuits thereon via the trunking interface 54, which may connect via trunks 24 to the various end offices 20, via trunks 32 to the MSCs 28. The packet interface 60 may also support communications with the signaling network 16 to facilitate call signaling and routing in traditional fashion. Generally, the computing module 52 controls circuit-switched communications via the switching fabric 50, and is capable of providing traditional intelligent network monitoring and functions. Further, the computing module 50 may provide the functionality associated with the present invention wherein the HLR database 36 for a given user element 30 may be accessed to identify the servicing MSC 28, and then route an incoming call directly to the servicing MSC 28 instead of the home MSC 28 for the user element 30. In essence, a traditional tandem switch 18 can be modified to access the HLR databases 36 and route calls according to the present invention.

Those skilled in the art will recognize improvements and modifications to the preferred embodiments of the present invention. For example, the direct call routing provided by the tandem switch 18 may route incoming calls from a wireless network 14 directly to the servicing MSC 28 in another wireless network 14. Also, functionality of the invention may be implemented using time-division multiplex (TDM) technology, such as that provided by Nortel Networks Limited's DMS-100, or packet technology, such as Nortel Networks Limited's Succession equipment. All such improvements and modifications are considered within the scope of the concepts disclosed herein and the claims that follow.

What is claimed is:

1. A method for routing a call to a user element on a wireless network via a wireline switch comprising:
a) receiving a request to route a call to a user element associated with a first wireless network and homed to a home mobile switching center forming part of the first wireless network;
b) accessing a home location register for the first wireless network to identify a servicing mobile switching center currently servicing the user element; and
c) routing the call to the servicing mobile switching center.

2. The method of claim 1 wherein the home mobile switching center is the servicing mobile switching center.

3. The method of claim 1 wherein the servicing mobile switching center is a mobile switching center other than the home mobile switching center.

4. The method of claim 1 wherein the servicing mobile switching center is part of the first wireless network.

5. The method of claim 1 wherein the servicing mobile switching center forms part of a second wireless network distinct from the first wireless network.

6. The method of claim 5 wherein the first and second wireless networks use distinct wireless communication technologies to facilitate wireless communications with the user element.

7. The method of claim 1 wherein the step of accessing the home location register comprises sending a request to identify the servicing mobile switching center to the home location register and receiving indicia identifying the servicing mobile switching center or routing information for the servicing mobile switching center.

8. The method of claim 1 further comprising determining that the call to the user element will be a wireless call and accessing a database to identify the home location register for the user element.

9. The method of claim 1 wherein the call is originated from customer premise equipment on a wireline network.

10. The method of claim 1 wherein the call is originated from customer premise equipment on a wireless network.

11. A wireline telephone switch comprising:
a) a first interface facilitating access to at least one home location register;
b) a second interface facilitating calls to a user element directly or indirectly via mobile switching centers; and
c) a computing module associated with the first and second interfaces and adapted to:
i) receive a request to route a call to a user element associated with a first wireless network and homed to a home mobile switching center forming part of the first wireless network;
ii) access a home location register for the first wireless network to identify a servicing mobile switching center currently servicing the user element; and
iii) route the call to the servicing mobile switching center.

12. The telephone switch of claim 11 wherein the home mobile switching center is the servicing mobile switching center.

13. The telephone switch of claim 11 wherein the servicing mobile switching center is a mobile switching center other than the home mobile switching center.

14. The telephone switch of claim 11 wherein the servicing mobile switching center is part of the first wireless network.

15. The telephone switch of claim 11 wherein the servicing mobile switching center forms part of a second wireless network distinct from the first wireless network.

16. The telephone switch of claim 15 wherein the first and second wireless networks use distinct wireless communication technologies to facilitate wireless communications with the user element.

17. The telephone switch of claim 11 wherein when accessing the home location register the computing module is further adapted to send a request to identify the servicing mobile switching center to the home location register and receive indicia identifying the servicing mobile switching center or routing information for the servicing mobile switching center.

18. The telephone switch of claim 11 wherein the computing module is further adapted to determine that the call to the user element will be a wireless call and access a database to identify the home location register for the user element.

19. The telephone switch of claim 11 wherein the call is originated from customer premise equipment on a wireline network.

20. The telephone switch of claim 11 wherein the call is originated from customer premise equipment on a wireless network.

21. The telephone switch of claim 11 further comprising a trunking interface connecting to a plurality of wireline end office switches.

22. The telephone switch of claim 11 wherein the telephone switch is a wireline tandem switch.

23. A wireline telephone switch for routing a call to a user element on a wireless network comprising:
a) means for receiving a request to route a call to a user element associated with a first wireless network and homed to a home mobile switching center forming part of the first wireless network;
b) means for accessing a home location register for the first wireless network to identify a servicing mobile switching center currently servicing the user element; and
c) means for routing the call to the servicing mobile switching center.

24. The telephone switch of claim 23 wherein the home mobile switching center is the servicing mobile switching center.

25. The telephone switch of claim 23 wherein the servicing mobile switching center is a mobile switching center other than the home mobile switching center.

26. The telephone switch of claim 23 wherein the servicing mobile switching center is part of the first wireless network.

27. The telephone switch of claim 23 wherein the servicing mobile switching center forms part of a second wireless network distinct from the first wireless network.

28. The telephone switch of claim 27 wherein the first and second wireless networks use distinct wireless communication technologies to facilitate wireless communications with the user element.

29. The telephone switch of claim 23 wherein the means for accessing the home location register further comprise means for sending a request to identify the servicing mobile switching center to the home location register and means for receiving indicia identifying the servicing mobile switching center or routing information for the servicing mobile switching center.

30. The telephone switch of claim 23 further comprising means for determining that the call to the user element will be a wireless call and accessing a database to identify the home location register for the user element.

31. The telephone switch of claim 23 wherein the call is originated from customer premise equipment on a wireline network.

32. The telephone switch of claim 23 wherein the call is originated from customer premise equipment on a wireless network.

33. The telephone switch of claim 23 further comprising means for interfacing with a plurality of wireline end office switches via trunks.

34. The telephone switch of claim 23 wherein the telephone switch is a wireline tandem switch.

35. A method for routing a call to a user element on a wireless network via a wireline switch comprising:
a) receiving a request to route a call to a user element associated with a first wireless network and homed to a home mobile switching center forming part of the first wireless network;
b) accessing a home location register for the first wireless network to identify a servicing mobile switching center currently servicing the user element; and
c) routing the call to a voicemail system for the servicing mobile switching center.
